(19) United States
(12) Patent Application Publication
(10) Pub. No.: US 2010/0138692 A1
(43) Pub. Date: Jun. 3, 2010

(54) ELECTRONIC DEVICE AND METHOD FOR RESTORING FUNCTION SETTINGS

(75) Inventor: YONG LIU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/558,678

(22) Filed: Sep. 14, 2009

(30) Foreign Application Priority Data
Nov. 28, 2008 (CN) 200810305852.6

(51) Int. Cl. G06F 11/14

(52) U.S. Cl. 714/15; 714/E11.113

(57) ABSTRACT

An electronic device and method for restoring personalized function settings include setting a restoring function, relating the restoring function to one or more function settings of the electronic device, and creating a backup file including retrieved personalized function settings of a designated function setting. The electronic device and method further include determining a backup file, and restoring the personalized function settings of a determined function setting corresponding to the determined backup file.

### BACKGROUND

1. Technical Field

Embodiments of the present disclosure relate to managing function settings, and more particularly to an electronic device and method for restoring function settings in the electronic device.

2. Description of Related Art

Electronic devices (e.g., mobile phones) have various functions. Each function may have different settings, such as factory settings and personalized settings, for example. If people changed their personalized settings temporarily, it is troublesome for people to restore the personalized settings one by one manually.

What is needed, therefore, is an improved electronic device and method for restoring function settings in the electronic device.

### BRIEF DESCRIPTION OF THE DRAWINGS

FIG. 1 is a block diagram of one embodiment of an electronic device including a setting restoring system.

FIG. 2 is a block diagram of one embodiment of the setting restoring system.

FIG. 3 is a schematic diagram of one embodiment of interfaces provided by the setting restoring system of FIG. 2.

FIG. 4 is a flowchart of one embodiment of a method for retrieving personalized function settings of a function setting in the electronic device of FIG. 1.

FIG. 5 is a flowchart of one embodiment of a method for restoring the personalized function settings of the function setting in the electronic device of FIG. 1.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

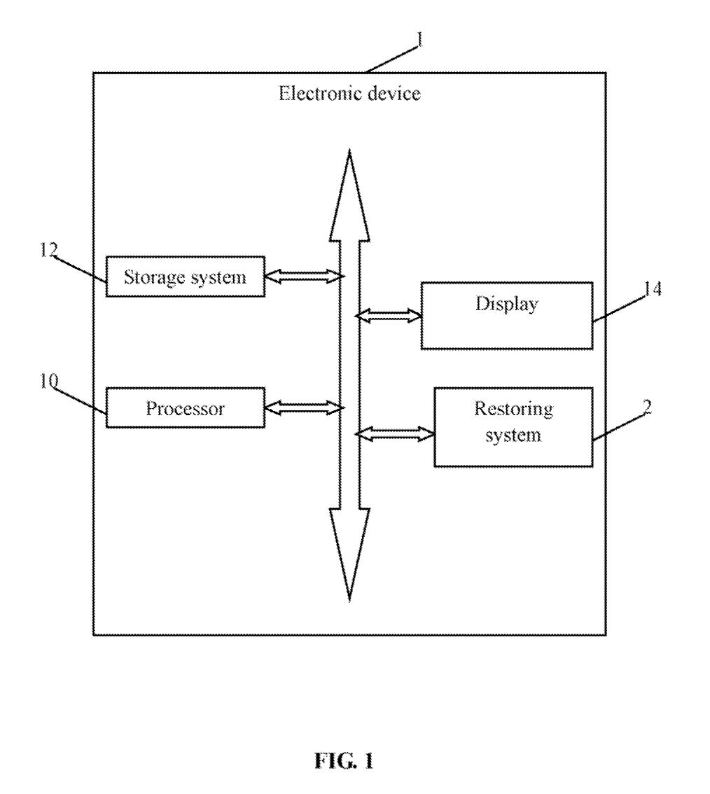

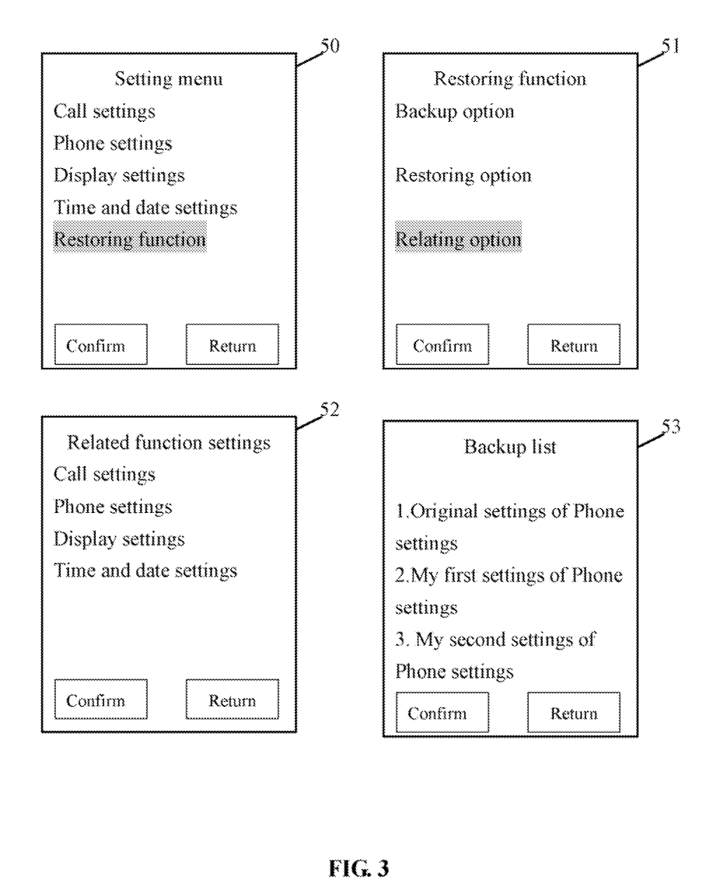

FIG. 1 is a block diagram of one embodiment of an electronic device 1 including a setting restoring system 2. The electronic device 1 has a setting menu displayed on a display 14, which lists one or more function settings of the electronic device 1. Each of the one or more function settings has original setting/configuration data and/or personalized function settings. The setting restoring system 2 may be used to restore the personalized function settings or original settings of a designated function setting if current settings of the designated function setting are not appropriate. As shown in an interface 50 of FIG. 3, the one or more function settings in the setting menu may include, but are not limited to, Call settings, Phone settings, Display settings, Time and date settings, for example.

The electronic device 1 may be a mobile phone, a personal digital assistant, a handheld computer, or any other kind of computing device. The electronic device 1 also includes a processor 10, a storage system 12, and the display 14. The processor 10 executes one or more computerized operations of the electronic device 1 and other applications, to provide the functions of the electronic device 1. The storage system 12 stores one or more programs, such as programs of an operating system, other applications of the electronic device 1, and various kinds of data, such as the personalized function settings and the original settings of the function settings of the electronic device 1, messages, or E-mails, for example. In one embodiment, the electronic device 1 may be a mobile phone, and the storage system 12 may be a memory of the electronic device 1 or an external storage card, such as a memory stick, a subscriber identification module (SIM) card, a smart media card, a compact flash card, or any other type of memory card. The display 14 may display various information, such as the messages, and user interfaces provided by the electronic device 1, for example.

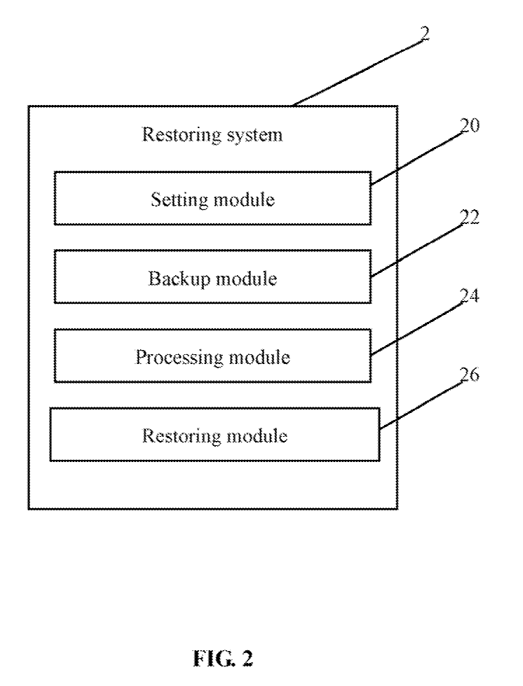

FIG. 2 is a block diagram of one embodiment of the setting restoring system 2. In one embodiment, the setting restoring system 2 includes a setting module 20, a backup module 22, a processing module 24, and a restoring module 26. The modules 20, 22, 24, and 26 may comprise one or more computerized operations to be executed by the processor 10 to perform one or more operations of the electronic device 1. Details of these operations will be provided below.

The setting module 20 is operable to set a restoring function in the setting menu of the electronic device 1. As mentioned above, the setting menu lists one or more function settings of the electronic device 1, and each of the one or more function settings has original setting/configuration data and/or personalized function settings. The one or more function settings in the setting menu may include, but are not limited to, Call settings, Phone settings, Display settings, Time and date settings, for example.

Further referring to FIG. 3, the restoring function is added in the setting menu as shown in the interface 50. The restoring function may be invoked/activated to restore the personalized function settings or the original settings of a designated function setting of the electronic device 1.

The setting module 20 is also operable to set options of the restoring function. As shown in an interface 51 of FIG. 3, the options of the restoring function may include a backup option, a restoring option, and a relating option, for example. Details of these options will be provided below.

The setting module 20 is further operable to relate the restoring function to one or more of the function settings in the setting menu by using the relating option. In one embodiment, as shown in an interface 52 of the FIG. 3, there are a plurality of related function settings of the restoring function, such as Call settings, Phone settings, Display settings, and Time and date settings, for example. In one embodiment, the related function settings may be determined according to user requirements. In another embodiment, the related function settings also may, by default, be all function settings in the setting menu without user selections.

The backup module 22 designates a function setting from the related function settings in response to user selections, and retrieves the personalized function settings of the designated function setting by invoking the backup option. In one embodiment, the designated function setting is the “Phone settings,” which have following personalized function settings: Language, Automatic keyboard, Cell information display, Welcome note, Network selection, Confirm SIM service actions, Help text activation, On/off, and Start-up tone, for example.

The backup module 22 also creates a backup file including the personalized function settings of the designated function setting, names the backup file, and stores the backup file in the storage system 12. In one embodiment, the setting module 20 may partition the storage system 12 into a plurality of storage areas, and determine a storage area to store the backup file. Then, the backup module 22 may store the backup file in the determined storage area.

The backup module 22 also creates a backup list, and adds the created backup file to the backup list. In one embodiment, as shown in an interface 53 of FIG. 3, a backup list includes three backup files: original settings of “Phone settings,” my first settings of “Phone settings,” and my second settings of “Phone settings,” for example. The original settings of “Phone settings” may be factory settings of the electronic device 1.

The processing module 24 may compress the backup file in the storage system 12.

The restoring module 26 determines a backup file from the backup list in response to the user selections, and determines a function setting corresponding to the determined backup file. The processing module 24 may decompress the determined backup file. Then the restoring module 26 invokes the restoring option, and restores the personalized function settings of the determined function setting by replacing current settings of the determined function setting with the personalized function settings in the determined backup file.

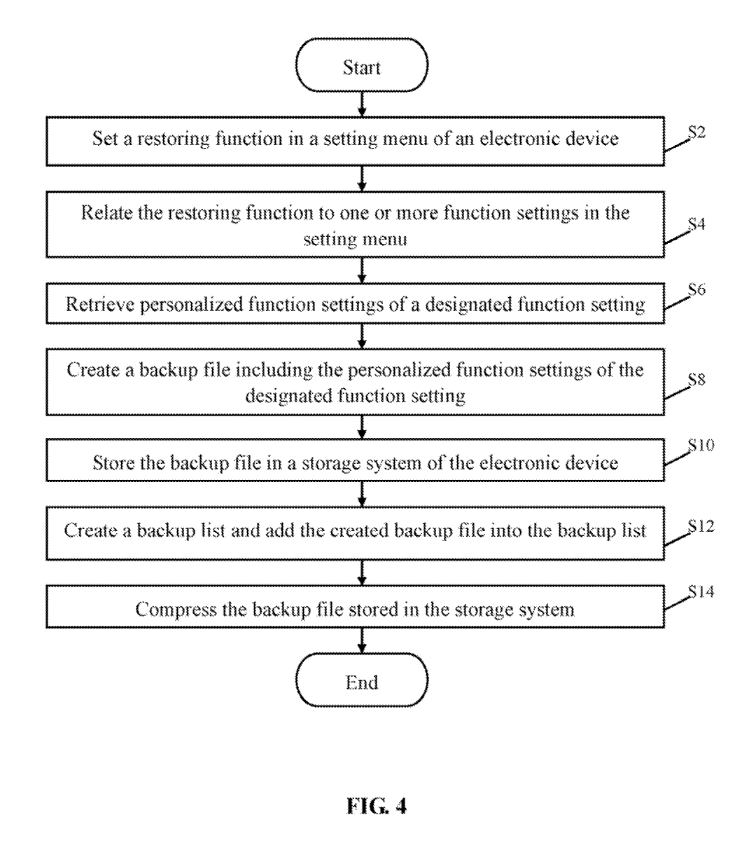

FIG. 4 is a flowchart of one embodiment of a method for retrieving personalized function settings of a function setting in the electronic device of FIG. 1. Depending on the embodiment, additional blocks may be added, others removed, and the ordering of the blocks may be replaced.

In block S2, the setting module 20 sets a restoring function in a setting menu of the electronic device 1, and sets options of the restoring function. As mentioned above, the setting menu lists one or more function settings of the electronic device 1, and each of the one or more function settings has original settings/configurations and/or personalized settings. In one embodiment, the options of the restoring function may include a backup option, a restoring option, and a relating option, for example.

In block S4, the setting module 20 relates the restoring function to one or more of the function settings in the setting menu by using the relating option.

In block S6, the backup module 22 designates a function setting from the related function settings in response to user selections, and retrieves the personalized function settings of the designated function setting by invoking the backup option.

In block S8, the backup module 22 creates a backup file including the personalized function settings of the designated function setting, and names the backup file.

In block S10, the backup module 22 stores the backup file in the storage system 12.

In block S12, the backup module 22 creates a backup list, and adds the created backup file to the backup list.

In block S14, the processing module 24 may compresses the backup file in the storage system 12.

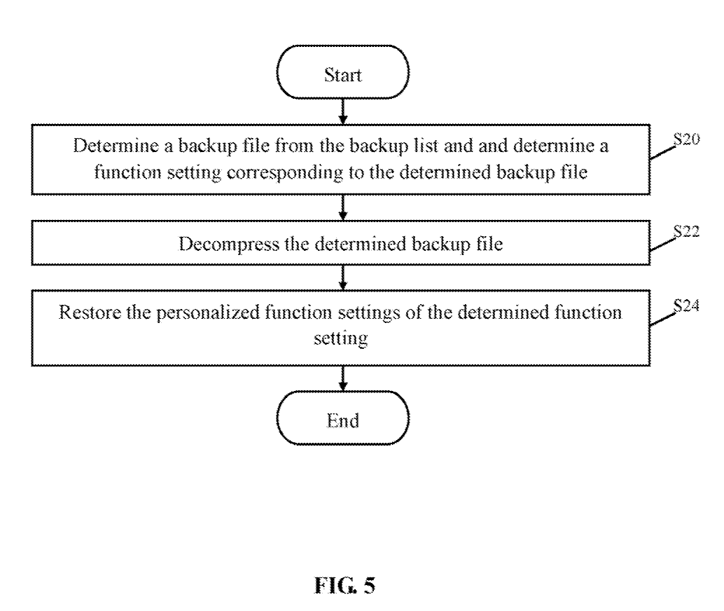

FIG. 5 is a flowchart of one embodiment of a method for restoring the personalized function settings of the function setting in the electronic device of FIG. 1.

In block S20, the restoring module 26 determines a backup file from the backup list in response to user selections, and determines a function setting corresponding to the determined backup file.

In block S22, the processing module 24 decompresses the determined backup file.

In block S24, the restoring module 26 restores the personalized function settings of the determined function setting by replacing current settings of the determined function setting with the personalized function settings in the determined backup file.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for restoring personalized function settings in an electronic device, the method comprising:
setting a restoring function in a setting menu displayed on a display of the electronic device;
relating the restoring function to one or more function settings in the setting menu, each of the one or more function settings having personalized function settings;
designating a function setting from the related one or more function settings in response to user selections;
retrieving personalized function settings of the designated function setting by invoking the restoring function;
creating a backup file comprising the personalized function settings of the designated function setting, and storing the backup file in a storage system of the electronic device;
creating a backup list, and adding the created backup file to the backup list;
determining a backup file from the backup list in response to the user selections;
determining a function setting corresponding to the determined backup file; and
restoring the personalized function settings of the determined function setting by replacing current settings of the determined function setting with the personalized function settings in the determined backup file.

2. The method according to claim 1, further comprising:
compressing the backup file in the storage system; and
decompressing the backup file before the restoring step.

3. The method according to claim 1, further comprising:
partitioning the storage system into a plurality of storage areas; and
determining a storage area to store the backup file and the backup list.

4. The method according to claim 1, further comprising:
naming the backup file.

5. The method according to claim 1, further comprising:
setting options of the restoring function, the options of the restoring function comprising a backup option, a restoring option, and a relating option.

6. An electronic device, the electronic device comprising:
a storage system;
at least one processor; and
one or more programs stored in the storage system and being executable by the at least one processor, the one or more programs comprising:
a setting module operable to set a restoring function in a setting menu displayed on a display of the electronic device, and relate the restoring function to one or more function settings in the setting menu, each of the one or more function settings having personalized function settings;
a backup module operable to designate a function setting from the related one or more function settings in response to user selections, retrieve personalized function settings of the designated function setting by invoking the restoring function, create a backup file comprising the personalized function settings of the designated function setting, store the backup file in the storage system, create a backup list, and add the created backup file to the backup list; and
a restoring module operable to determine a backup file from the backup list in response to the user selections, determine a function setting corresponding to the determined backup file, and restore the personalized function settings of the determined function setting by replacing current settings of the determined function setting with the personalized function settings in the determined backup file.

7. The electronic device according to claim 6, wherein the one or more programs further comprises a processing module operable to compress the backup file in the storage system, and decompress the backup file before restoring the personalized settings of the designated function setting.

8. The electronic device according to claim 6, wherein the setting module is further operable to partition the storage system into a plurality of storage areas, and determine a storage area to store the backup file and the backup list.

9. The electronic device according to claim 6, wherein the backup module is further operable to name the backup file.

10. The electronic device according to claim 6, wherein the setting module is further operable to set options of the restoring function, the options of the restoring function comprising a backup option, a restoring option, and a relating option.

11. A storage medium storing a set of instructions, the set of instructions capable of being executed by a processor to perform a method for restoring personalized function settings in an electronic device, the method comprising:
setting a restoring function in a setting menu displayed on a display of the electronic device;
relating the restoring function to one or more function settings in the setting menu, each of the one or more function settings having personalized function settings;
designating a function setting from the related one or more function settings in response to user selections;
retrieving personalized function settings of the designated function setting by invoking the restoring function;
creating a backup file comprising the personalized function settings of the designated function setting, and storing the backup file in a storage system of the electronic device;
creating a backup list, and adding the created backup file to the backup list;
determining a backup file from the backup list in response to the user selections;
determining a function setting corresponding to the determined backup file; and
restoring the personalized function settings of the determined function setting by replacing current settings of the determined function setting with the personalized function settings in the determined backup file.

12. The storage medium as claimed in claim 11, wherein the method further comprises:
compressing the backup file in the storage system; and
decompressing the backup file before the restoring step.

13. The storage medium as claimed in claim 11, wherein the method further comprises:
partitioning the storage system into a plurality of storage areas; and
determining a storage area to store the backup file and the backup list.

14. The storage medium as claimed in claim 11, wherein the method further comprises:
naming the backup file.

15. The storage medium as claimed in claim 11, wherein the method further comprises:
setting options of the restoring function, the options of the restoring function comprising a backup option, a restoring option, and a relating option.
